(19) United States
(12) Patent Application Publication
(10) Pub. No.: US 2024/0320131 A1
(43) Pub. Date: Sep. 26, 2024

(54) AUTOMATED GENERATION OF SOFTWARE TESTS

(71) Applicant: Functionize, Inc., Walnut Creek, CA (US)

(72) Inventor: Tamas Cser, Las Vegas, NV (US)

(21) Appl. No.: 18/609,208

(22) Filed: Mar. 19, 2024

Related U.S. Application Data
(60) Provisional application No. 63/491,101, filed on Mar. 20, 2023.

(51) Int. Cl. G06F 11/36

(52) U.S. Cl. CPC G06F 11/3684

(57) ABSTRACT

Provided herein is a technology relating to testing software and particularly, but not exclusively, to methods and systems for generating software test case scripts using a corpus of application test case scripts provided in a textual representation as base user interaction training data and recorded user action training data provided in a textual representation as application-specific training data to train a generative pretrained transformer model.

This application claims the benefit of U.S. provisional patent application Ser. No. 63/491,101, filed Mar. 20, 2023, which is incorporated herein by reference in its entirety.

### FIELD

Provided herein is technology relating to testing software applications and particularly, but not exclusively, to methods and systems for generating software test scripts using recorded user actions and a predictive language model.

### BACKGROUND

A software application is typically tested to confirm that the application performs according to specifications. In particular, testing software applications involves producing a computer executable test script that describes a user interaction with the application as a series of steps (e.g., actions performed on elements of a graphical user interface of the application) that produce an expected outcome. In many cases, developers manually produce the test script in a scripting language. However, manual scripting of test scripts is time consuming, expensive, and error prone. While some tools are available for automated testing of applications, these current technologies do not accurately reproduce human interaction with a software application.

### SUMMARY

Accordingly, provided herein is a technology that represents user interaction with a graphical user interface in a textual representation to train a machine learning model (e.g., a generative pretrained transformer deep learning model) and then use the trained model to output software application test cases. As described herein, the technology uses a language model approach to learn patterns of user interaction with a graphical user interface of an application. Further, the technology encodes data, elements, and user actions on elements in a textual representation.

For example, embodiments provide a method for generating a software application test case for an application. In some embodiments, methods comprise providing a machine learning model; training the machine learning model with a base user interaction training dataset to produce a base model; and training the base model with an application-specific training dataset to provide a fine-tuned model for an application. In some embodiments, methods further comprise generating by the fine-tuned model a software application test case comprising a sequence of user actions on a graphical user interface of the application. In some embodiments, the machine learning model is a generative pretrained transformer. In some embodiments, the base user interaction training dataset comprises a large corpus of manually scripted software test cases. In some embodiments, each manually scripted software test case of the large corpus of manually scripted software test cases is provided in a standard format for data serialization and/or data interchange. In some embodiments, the base user interaction training dataset comprises a plurality of software test cases for a wide range of applications, a wide range of use cases, and/or has a reasonable distribution of test case lengths. In some embodiments, the application-specific training dataset is provided by recording user actions on a graphical user interface of the application to provide a dataset of sequential user actions. In some embodiments, the dataset of sequential user actions is provided in a standard format for data interchange. In some embodiments, the application-specific training dataset comprises data describing sequences of user actions performed by a number of users interacting with the application, data describing sequences of user actions performed by a number of users interacting with the application on a number of devices; and/or data describing sequences of user actions performed by a number of users interacting with the application at a number of different times. In some embodiments, methods further comprise inputting to the fine-tuned model a sequence of user actions on a graphical user interface of an application to generate a software application test case comprising a sequence of user actions on a graphical user interface of the application; scoring the software application test case using a reward model; training a reinforcement learning model; and adjusting weights of the fine-tuned model. In some embodiments, the reinforcement learning model is a Proximal Policy Optimization (PPO) model. In some embodiments, methods further comprise providing a runtime agent; requesting by the runtime agent a predicted next step from the fine-tuned model for an application at runtime of the application; and executing the predicted next step on the application. In some embodiments, methods further comprise generating executable code in a programming language to perform the software application test case.

The technology further provides embodiments of systems for generating a software application test case for an application. In some embodiments, systems comprise a machine learning model; a base user interaction training dataset; and an application-specific training dataset. In some embodiments, the machine learning model is a generative pretrained transformer. In some embodiments, the base user interaction training dataset comprises a large corpus of manually scripted software test cases. In some embodiments, each manually scripted software test case of the large corpus of manually scripted software test cases is provided in a standard format for data serialization and/or data interchange. In some embodiments, the base user interaction training dataset comprises a plurality of software test cases for a wide range of applications, a wide range of use cases, and/or has a reasonable distribution of test case lengths. In some embodiments, systems further comprise a recorder that records user actions on a graphical user interface of the application to provide a dataset of sequential user actions. In some embodiments, systems comprise a code snippet comprising instructions for recording user actions on a graphical user interface of the application to provide a dataset of sequential user actions. In some embodiments, the dataset of sequential user actions is provided in a standard format for data interchange. In some embodiments, systems further comprise a dictionary that comprises a list of integers and a vocabulary of words or subwords; and that defines a one-to-one correspondence between each integer of the list of integers and each word or subword of the vocabulary. In some embodiments, systems further comprise a reward model and a reinforcement learning model. In some embodiments, the reinforcement learning model is a Proximal Policy Optimization (PPO) model. In some embodiments, systems further comprise a runtime agent that performs a number of steps output by a fine-tuned model on a graphical user interface of an application.

Some portions of this description describe the embodiments of the technology in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times to refer to these arrangements of operations as modules, without loss of generality. The described operations and their associated modules may be embodied in software, firmware, hardware, or any combinations thereof.

Certain steps, operations, or processes described herein may be performed or implemented with one or more hardware or software modules, alone or in combination with other devices. In some embodiments, a software module is implemented with a computer program product comprising a computer-readable medium containing computer program code, which can be executed by a computer processor for performing any or all steps, operations, or processes described.

In some embodiments, systems comprise a computer and/or data storage provided virtually (e.g., as a cloud computing resource). In particular embodiments, the technology comprises use of cloud computing to provide a virtual computer system that comprises the components and/or performs the functions of a computer as described herein. Thus, in some embodiments, cloud computing provides infrastructure, applications, and software as described herein through a network and/or over the internet. In some embodiments, computing resources (e.g., data analysis, calculation, data storage, application programs, file storage, etc.) are remotely provided over a network (e.g., the internet; and/or a cellular network).

Embodiments of the technology may also relate to an apparatus for performing the operations herein. This apparatus may be specially constructed for the required purposes (e.g., an application-specific integrated circuit or a field-programmable gate array) and/or it may comprise a general-purpose computing device (e.g., a microcontroller, microprocessor, and the like) selectively activated or reconfigured by a computer program stored in the computer or other user device. The apparatus may be configured to perform one or more steps, actions, and/or functions described herein, e.g., provided as instructions of a computer program. Such a computer program may be stored in a non-transitory, tangible computer readable storage medium or any type of media suitable for storing electronic instructions, which may be coupled to a computer system bus. Furthermore, any computing systems referred to in the specification may include a single processor or may be architectures employing multiple processor designs for increased computing capability.

For example, e.g., as shown in FIG. 1, the technology relates to a system 100 for generating test cases for an application. The system 100 comprises a server 110 and one or more user devices 121, 122, 123. The server 110 and the user devices 121, 122, 123 communicate over one or more wired or wireless communication networks 130. Portions of the wireless communication networks 130 may be implemented using a wide area network (e.g., the Internet), a local area network (e.g., a BLUETOOTH network or wireless local area network), and combinations or derivatives thereof. It should be understood that the server 110 may communicate with a different number of user devices, and the three user devices 121, 122, 123 shown in FIG. 1 are purely for illustrative purposes. Similarly, it should also be understood that the system 100 may include a number of servers and the single server 110 shown in FIG. 1 is purely for illustrative purposes. Also, in some embodiments, one of the user devices 121, 122, 123 may communicate with the server 110 through one or more intermediary devices (not shown). In some embodiments, the user devices 121, 122, 123 may communicate directly to one another.

In addition to an apparatus provided for performing operations as described herein, embodiments of technology provide an input device and a display device in electrical communication with the apparatus. See, e.g., FIG. 5. The display device may include, for example, a touchscreen, a liquid crystal display (“LCD”), a light-emitting diode (“LED”), a LED display, an organic LED (“OLED”) display, an electroluminescent display (“ELD”), and the like. The input device may include, for example, a keypad, a mouse, a touchscreen (for example, as part of the display device), a microphone, a camera, or the like. The processor, a memory, a communication interface, the input device, and the display device communicate over one or more communication lines or buses, wirelessly, or a combination thereof. It should be understood that the user device may include additional components in various configurations and may perform additional functionality than the functionality described herein. For example, in some embodiments, the user device includes multiple electronic processors, multiple memories, multiple communication interfaces, multiple input devices, multiple output devices, or a combination thereof. Also, it should be understood that, although not described or illustrated herein, the user devices may include similar components and perform similar functionality as the user device.

The technology relates to user interaction with a graphical user interface provided on a display device. When executed by a computer in coordination with a software application (for example, an operating system), the graphical user interface software presents a graphical user interface on the display device. The graphical user interface includes one or more graphical user interface elements.

In some embodiments, steps of the described methods are implemented in software code, e.g., a series of procedural steps instructing a computer and/or a microprocessor to produce and/or transform data as described herein. In some embodiments, software instructions are encoded in a programming language.

In some embodiments, one or more steps or components are provided in individual software objects connected in a modular system. In some embodiments, the software objects are extensible and portable. In some embodiments, the objects comprise data structures and operations that transform the object data. In some embodiments, the objects are used by manipulating their data and invoking their methods. Accordingly, embodiments provide software objects that imitate, model, or provide concrete entities, e.g., for numbers, shapes, data structures, that are manipulable. In some embodiments, software objects are operational in a computer, device, or in a microprocessor. In some embodiments, software objects are stored on a computer readable medium.

In some embodiments, a step of a method described herein is provided as an object method. In some embodiments, data and/or a data structure described herein is provided as an object data structure.

Some embodiments provide an object-oriented pipeline that performs methods as described herein, e.g., for training a machine learning model, recording user interactions with a graphical user interface of an application, transforming user interaction data into a text-based sequence of user actions, and producing a test case comprising a series of user actions. Embodiments comprise use of code that produces and manipulates software objects, e.g., as encoded using a programming language.

Additional embodiments will be apparent to persons skilled in the relevant art based on the teachings contained herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

These and other features, aspects, and advantages of the present technology will become better understood with regard to the following drawings.

FIG. 1 is a block diagram of an embodiment of a system described herein.

FIG. 2 is a flowchart describing an embodiment of the technology described herein.

FIG. 3 shows a portion of an exemplary training dataset in a JSON-formatted textual representation of user interaction with the graphical user interface.

FIG. 4 is a block diagram of an example server as shown in the system shown in FIG. 1.

FIG. 5 is a block diagram of an example user device as shown in the system shown in FIG. 1.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DETAILED DESCRIPTION

Provided herein is a technology that represents user interaction with a graphical user interface in a textual representation to train a machine learning model (e.g., a generative pretrained transformer deep learning model) and use the trained model to output software application test cases.

In this detailed description of the various embodiments, for purposes of explanation, numerous specific details are set forth to provide a thorough understanding of the embodiments disclosed. One skilled in the art will appreciate, however, that these various embodiments may be practiced with or without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the various embodiments disclosed herein.

All literature and similar materials cited in this patent application, including but not limited to, patents, patent applications, articles, books, treatises, and internet web pages are expressly incorporated by reference in their entirety for any purpose. Unless defined otherwise, all technical and scientific terms used herein have the same meaning as is commonly understood by one of ordinary skill in the art to which the various embodiments described herein belongs. When definitions of terms in incorporated references appear to differ from the definitions provided in the present teachings, the definition provided in the present teachings shall control. The section headings used herein are for organizational purposes only and are not to be construed as limiting the described subject matter in any way.

### Definitions

To facilitate an understanding of the present technology, a number of terms and phrases are defined below. Additional definitions are set forth throughout the detailed description.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator and is equivalent to the term “and/or” unless the context clearly dictates otherwise. The term “based on” is not exclusive and allows for being based on additional factors not described, unless the context clearly dictates otherwise. In addition, throughout the specification, the meaning of “a”, “an”, and “the” include plural references. The meaning of “in” includes “in” and “on.”

As used herein, the terms “about”, “approximately”, “substantially”, and “significantly” are understood by persons of ordinary skill in the art and will vary to some extent on the context in which they are used. If there are uses of these terms that are not clear to persons of ordinary skill in the art given the context in which they are used, “about” and “approximately” mean plus or minus less than or equal to 10% of the particular term and “substantially” and “significantly” mean plus or minus greater than 10% of the particular term.

As used herein, disclosure of ranges includes disclosure of all values and further divided ranges within the entire range, including endpoints and sub-ranges given for the ranges. As used herein, the disclosure of numeric ranges includes the endpoints and each intervening number therebetween with the same degree of precision. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9, and 7.0 are explicitly contemplated.

As used herein, the suffix “.free” refers to an embodiment of the technology that omits the feature of the base root of the word to which “-free” is appended. That is, the term “X-free” as used herein means “without X”, where X is a feature of the technology omitted in the “X-free” technology. For example, a “calcium-free” composition does not comprise calcium, a “mixing-free” method does not comprise a mixing step, etc.

Although the terms “first”, “second”, “third”, etc. may be used herein to describe various steps, elements, compositions, components, regions, layers, and/or sections, these steps, elements, compositions, components, regions, layers, and/or sections should not be limited by these terms, unless otherwise indicated. These terms are used to distinguish one step, element, composition, component, region, layer, and/or section from another step, element, composition, component, region, layer, and/or section. Terms such as “first”, “second”, and other numerical terms when used herein do not imply a sequence or order unless clearly indicated by the context. Thus, a first step, element, composition, component, region, layer, or section discussed herein could be termed a second step, element, composition, component, region, layer, or section without departing from technology.

As used herein, the word “presence” or “absence” (or, alternatively, “present” or “absent”) is used in a relative sense to describe the amount or level of a particular entity (e.g., component, action, element). For example, when an entity is said to be “present”, it means the level or amount of this entity is above a pre determined threshold; conversely, when an entity is said to be “absent”, it means the level or amount of this entity is below a pre-determined threshold. The pre determined threshold may be the threshold for detectability associated with the particular test used to detect the entity or any other threshold. When an entity is “detected” it is “present”; when an entity is “not detected” it is “absent”.

As used herein, an “increase” or a “decrease” refers to a detectable (e.g., measured) positive or negative change, respectively, in the value of a variable relative to a previously measured value of the variable, relative to a pre-established value, and/or relative to a value of a standard control. An increase is a positive change preferably at least 10%, more preferably 50%, still more preferably 2-fold, even more preferably at least 5-fold, and most preferably at least 10-fold relative to the previously measured value of the variable, the pre-established value, and/or the value of a standard control. Similarly, a decrease is a negative change preferably at least 10%, more preferably 50%, still more preferably at least 80%, and most preferably at least 90% of the previously measured value of the variable, the pre-established value, and/or the value of a standard control. Other terms indicating quantitative changes or differences, such as “more” or “less,” are used herein in the same fashion as described above.

As used herein, a “system” refers to a plurality of real and/or abstract components operating together for a common purpose. In some embodiments, a “system” is an integrated assemblage of hardware and/or software components. In some embodiments, each component of the system interacts with one or more other components and/or is related to one or more other components. In some embodiments, a system refers to a combination of components and software for controlling and directing methods. For example, a “system” or “subsystem” may comprise one or more of, or any combination of, the following: mechanical devices, hardware, components of hardware, circuits, circuitry, logic design, logical components, software, software modules, components of software or software modules, software procedures, software instructions, software routines, software objects, software functions, software classes, software programs, files containing software, etc., to perform a function of the system or subsystem. Thus, the methods and apparatus of the embodiments, or certain aspects or portions thereof, may take the form of program code (e.g., instructions) embodied in tangible media, such as floppy diskettes, CD-ROMs, hard drives, flash memory, or any other machine-readable storage medium wherein, when the program code is loaded into and executed by a machine, such as a computer, the machine becomes an apparatus for practicing the embodiments. In the case of program code execution on programmable computers, the computing device generally includes a processor, a storage medium readable by the processor (e.g., volatile and non-volatile memory and/or storage elements), at least one input device, and at least one output device. One or more programs may implement or utilize the processes described in connection with the embodiments, e.g., through the use of an application programming interface (API), reusable controls, or the like. Such programs are preferably implemented in a high-level procedural or object-oriented programming language to communicate with a computer system. However, the program(s) can be implemented in assembly or machine language, if desired. In any case, the language may be a compiled or interpreted language, and combined with hardware implementations.

As used herein, the term “machine learning algorithm” refers to a method that produces a machine learning model (e.g., by receiving data as an input and performing the algorithm on the data). In some embodiments, a machine learning algorithm comprises recognizing patterns in data to determine or “learn” from the data how to generate output or make a prediction based on input data. In some embodiments, a machine learning algorithm is described using a mathematical equation, pseudocode, or using code in a specific programming language (e.g., BASIC, Java, C, C++, C#, Objective-C, MATLAB, Mathematica, Python, R, PHP, Ruby, Perl, Object Pascal, Swift, Scala, Common Lisp, or Smalltalk, etc.) In some embodiments, computer science techniques may be used to evaluate the efficiency of a machine learning algorithm. In some embodiments, a machine learning algorithm comprises an optimization method that minimizes an error calculated from data and/or a prediction algorithm for a training dataset.

As used herein, the term “machine learning model” or “model” refers to the output of a machine learning algorithm. In some embodiments, a machine learning model is a machine learning algorithm that has been optimized (e.g., having optimized parameters) using training data to identify certain patterns in data or produce certain outputs. In some embodiments, a machine learning model comprises a saved set of rules, parameterized algorithms, numbers, methods, and/or data structures that are produced by the machine learning algorithm using training data and that may be used to make predictions or produce output using new data as input. That is, a machine learning model is a program created by performing the machine learning algorithm on data to produce a trained model that is used for prediction or output when provided with new data.

As used herein, the term “model training” or “training a model” and the like refers to a method comprising inputting a dataset (called training data) to a machine learning algorithm and optimizing the algorithm to identify certain patterns or produce certain outputs. The resulting rules, parameterized algorithms, numbers, methods, and/or data structures is called the trained machine learning model. Accordingly, a machine learning algorithm may be trained to produce a machine learning model and, because a machine learning model is an optimized machine learning algorithm, a machine learning model may be trained (and retrained) by inputting a dataset into the machine learning model.

As used herein, the term “machine learning network” refers to a machine learning algorithm or machine learning model having a defined organization of algorithms, functions, methods, weights, parameters, data flows between algorithms or methods, and/or data formats used for input and output. In some embodiments, a machine learning network comprises weights applied to data communicated within the network; and/or weights applied to parameters used in algorithms, functions, or methods. In some embodiments, the organization is described as a hierarchy of layers between which inputs and outputs are communicated.

As used herein, the term “machine learning architecture” refers to a specific organizational structure of a machine learning network. A machine learning architecture may be described in terms of a map or topology (e.g., comprising nodes, connections between nodes, weights of nodes, directions of flow between nodes).

As used herein, a machine learning “node” refers to a computational unit that has one or more weighted input connections, a function (e.g., comprising an algorithm, method, function) that transforms the inputs, and an output connection. In some embodiments, nodes are organized into layers to comprise a machine learning network comprising a particular machine learning architecture.

As used herein, the term “element”, when referring to a graphical user interface of an application, refers to a component of the graphical user interface upon which a user performs an action. Exemplary elements include but are not limited to a window, a menu, a menu item, a drop down menu, a combo box, a spin button, a tool bar, a widget, an image, a tab strip, a tab, a thumbnail, a checkbox, a button, a radio button, a drop down list, a list box, a list item, a dropdown button, a hyperlink, a toggle, a text box, a text area, a text field, a visual button, a search field, a scroll bar, a dial, and a slider. An element may have a unique identifier that is a string, such as a name, number, or symbol. Accordingly, the element may be referenced and/or retrieved using the identifier. Further, if a particular element is the first child element of a parent element, then the particular element may be referenced and/or retrieved using a pointer to the parent element and then retrieving a pointer to the first child element. An application may provide one or more Application Programming Interfaces (“APIs”) for referencing and/or retrieving elements. Thus, in some embodiments, the term “element” refers to a component of a software application with which a user (e.g., a person, another application, an application programming interface, etc.) interacts. In some embodiments, interacting with an element causes the application to perform a function. In some embodiments, an element is a web page or screen. In some embodiments, an element comprises other elements, e.g., a web page comprising one or more buttons, text fields, etc. In some embodiments, source code corresponding to an element or associated with an element is mappable to a visible element presented on a screen of a client device for viewing by a user. An element has one or more attributes and/or attribute values, e.g., that can be provided by analyzing the visual render, text, code, and/or context of the element.

As used herein, the term “target element” is an element on which an action (e.g., an action of a step of a test case) is to be performed (e.g., by the step of the test case). For example, if a step of a test case is “click on the login button”, the element that is the login button is the target element of the test case step.

As used herein, the term “attribute” refers to data that identify and/or describe the appearance, behavior, and/or content of an element. An element may have any number of attributes, e.g., element type; location on a screen, window or page; color; text; size; border; typeface; and code associated with the element. In some embodiments, attributes have “attribute values”—for example, the location attribute may have an attribute value comprising x, y coordinates describing a screen location. Attribute values may be integral, continuous, and/or discontinuous; numbers; classes; types; categories; etc.

As used herein, the term “action”, when referring to a graphical user interface of an application, refers to an action performed by a user on an element of a graphical user interface, e.g., by manipulating an input device and thereby controlling a cursor, entering text, or otherwise providing input to the application through the graphical user interface. Exemplary actions include a left click, a right click, a drag, a drag and drop, a hover, a double click, keyboard input, a mouseover, a mousedown, a mouseup. In some embodiments, an action may be performed by a computer simulating the actions of a human user (e.g., by executing a test script or by a runtime agent requesting and executing steps from a fine-tuned model).

As used herein, the term “selector” refers to a pattern used to identify and/or locate elements on a graphical user interface.

As used herein, the term “test case” refers to a defined set of actions and/or inputs performed on a software application that generates a defined set of outputs. Generally, a test case includes instructions specifying actions and/or inputs, predicted results, and a set of execution conditions. The test case can be viewed as a predetermined collection of one or more actions involving one or more elements of a software application. In some embodiments, a test case comprises a series of actions and/or inputs executed in a predetermined order specified in a test case script to simulate use of a software application or system by a user. Each input and/or action executed may be represented by individual test cases that can be joined together to represent a more complex sequence of actions within a larger test case. In some embodiments, a test case is executed to identify errors needing repair in a software application or in components of an interrelated system.

As used herein, the term “script” or “test script” refers to an implementation of a test case in a particular script language. In some embodiments, a script is a written description of the set of inputs and/or actions to be executed in a test case and a list of expected results for comparison to the actual results. A script is typically associated with each test case. The instructions for inputs and/or actions to execute in a script may be written in descriptive terms to tell a human operator what transactions to execute or it may comprise or access computer instructions to execute the transactions automatically without human user interaction or with minimal or reduced human user interaction. In some embodiments, a script may comprise a combination of computer-executed and human-executed instructions.

As used herein, the term “interaction”, e.g., when referring to a user interaction with a graphical user interface of an application, refers to a sequence of actions performed by a user or simulated user on the graphical user interface of the application.

As used herein, the term “device” or “user device” refers to a laptop computer, a desktop computer, a tablet computer, a smart phone, or other computing device. The term “device” or “user device” also refers to virtual machines emulating a physical device (e.g., a virtual machine emulating a laptop computer, a desktop computer, a tablet computer, a smart phone, or other computing device). A “computer program”, “computer executable code”, and the like refers to a program or executable code that may be executed by a processor of a device and is not limited to a program or executable code that is executable only by a computer, though it may be.

As used herein, the term “application” or “software application” is a computer program designed to carry out one or more task(s) on a user device and includes, but is not limited to, web-based (e.g., browser-based) applications, mobile applications, operating systems, and utilities. In some contexts of this description, the term “application” refers to a patent application and is distinguishable by one of ordinary skill in the art based on its use and context from references to the term “application” referring to a computer program.

As used herein, the term “user” refers to a person (e.g., real or virtual) that interacts with an application (e.g., with an element of an application). In some embodiments, a user is a person (e.g., that interacts with an application through a graphical user interface). In some embodiments, a user is another application (e.g., a script) or software component (e.g., a runtime agent) that interacts with an application.

### DESCRIPTION

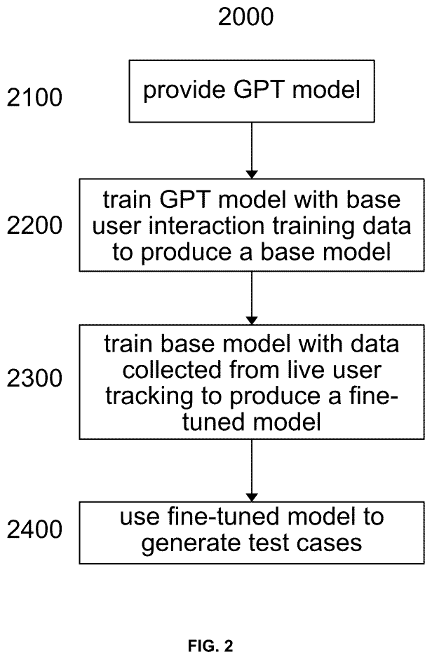

Provided herein is a technology that represents user interaction with a graphical user interface in a textual representation to train a machine learning model (e.g., a generative pretrained transformer deep learning model) and then use the trained model to output software application test cases. Training a machine learning model comprises multiple steps including preparing and preprocessing data describing user interaction with a graphical user interface of an application to provide a textual representation of user interaction with the graphical user interface, training the machine learning model using the textual representation of user interaction with the graphical user interface, and fine-tuning the machine learning model to improve its performance for a specific application. Accordingly, embodiments comprise training the machine learning model with base user interaction training data to provide a base model and further training the base model with additional training data collected for a specific application to produce a fine-tuned model. In some embodiments, the base user interaction training data comprises a large body of user interaction training data. FIG. 2 is a flowchart describing an exemplary embodiment of a method 2000 comprising providing 2100 a GPT model, training 2200 the GPT model with base user interaction training data to produce a base model, training 2300 the base model using with data collected from live user tracking to produce a fine-tuned model, and using 2400 the fine-tuned model to generate software application test cases.

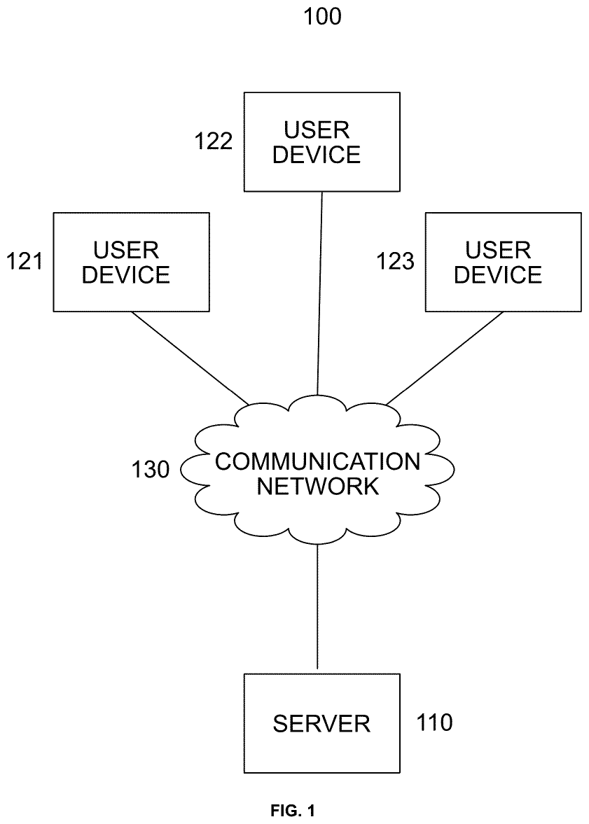

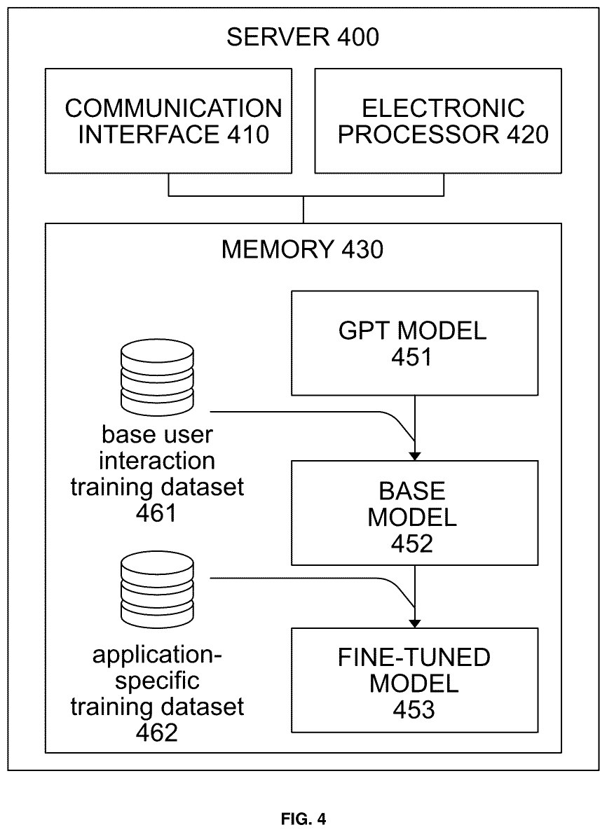

In some embodiments, e.g., as shown in FIG. 4, the technology relates to embodiments of a server 400. For example, as shown in FIG. 4, the server 400 is an electronic computing device comprising an electronic processor 420 (for example, a microprocessor, application-specific integrated circuit (ASIC), or another suitable electronic device), a memory 430 (a non-transitory, computer-readable storage medium), and a communication interface 410, for example, a transceiver, for communicating over the communication network(s) 130 (as shown in FIG. 1) and, optionally, one or more additional communication networks or connections. The electronic processor 420, the memory 430, and the communication interface 410 communicate wirelessly, over one or more communication lines or buses, or a combination thereof. It should be understood that the server 400 may include additional components than those illustrated in FIG. 4 in various configurations and may perform additional functionality than the functionality described herein. Furthermore, the functionality described herein as being performed by the server 400 may be performed in a distributed nature via a plurality of servers or similar devices included in a cloud computing environment. As described herein, embodiments of the server may comprise a generative pretrained transformer (GPT) model 451. Training the GPT model 451 with a base user interaction training dataset 461 (e.g., stored in memory 430) produces a base model 452, and training the base model 452 with an application-specific training dataset 462 (e.g., stored in memory 430) produces a fine-tuned model 453.

When executed by the electronic processor 420, the machine learning models 451, 452, 453 may perform a set of functions, including embodiments of methods described herein. Each of the machine learning models 451, 452, 453 may be a GPT model. It should be understood that the functionality described herein as being performed by each of the machine learning models 451, 452, 453 may be distributed among multiple applications or software components.

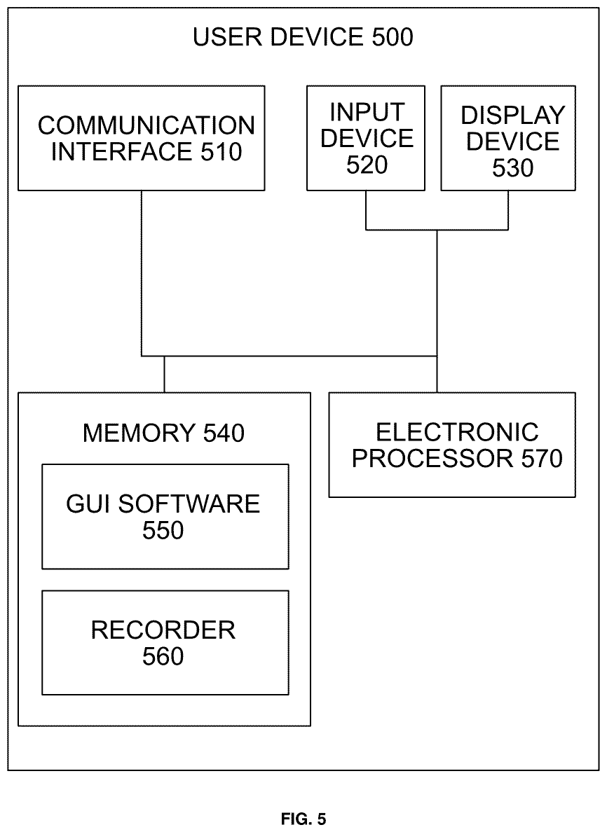

In some embodiments, e.g., as shown in FIG. 5, the technology relates to a user device 500. The user device 500 may be a laptop computer, a desktop computer, a tablet computer, a smart phone, or other computing device. As illustrated in FIG. 5, the user device 500 is electronic computing device that includes an electronic processor 570 (for example, a microprocessor, application-specific integrated circuit (ASIC), or another suitable electronic device), a memory 540 (a non-transitory, computer-readable storage medium), and a communication interface 510, for example, a transceiver, for communicating over the communication network(s) 130 (as shown in FIG. 1) and, optionally, one or more additional communication networks or connections. The communication interface 510 allows the user device 500 to communicate with a server 400 over the communication network(s) 130.

The user device 500 also includes an input device 520 and a display device 530. The display device 530 may include, for example, a touchscreen, a liquid crystal display (“LCD”), a light-emitting diode (“LED”), a LED display, an organic LED (“OLED”) display, an electroluminescent display (“ELD”), and the like. The input device 520 may include, for example, a keypad, a mouse, a touchscreen (for example, as part of the display device 530), a microphone, a camera, or the like (not shown). The electronic processor 570, the memory 540, the communication interface 510, the input device 520, and the display device 530 communicate over one or more communication lines or buses, wirelessly, or a combination thereof. It should be understood that the user device 500 may include additional components than those illustrated in FIG. 5 in various configurations and may perform additional functionality than the functionality described herein. For example, in some embodiments, the user device 500 includes multiple electronic processors, multiple memories, multiple communication interfaces, multiple input devices, multiple output devices, or a combination thereof. Also, it should be understood that, although not described or illustrated herein, the user devices 121, 122, 123 may include similar components and perform similar functionality as the user device 500.

As illustrated in FIG. 5, the memory 540 included in the user device 500 includes graphical user interface software 550, e.g., for producing a graphical user interface on the display device 530. In some embodiments, the memory further comprises a recorder 560. When executed by the electronic processor 570 in coordination with a software application (for example, an operating system), the graphical user interface software 550 presents a graphical user interface on the display device 530. The graphical user interface includes one or more graphical user interface elements (e.g., a window, a tab, a checkbox, a button, a radio button, a drop down list, a list box, a dropdown button, a toggle, a text field, a visual button, a search field, a scroll bar, a dial, and a slider). It should be understood that the functionality described herein as being performed by the graphical user interface software 550 and by the recorder 560 may be distributed among multiple applications or software components.

### Generative Pretrained Transformer Model

For example, in some embodiments, methods comprise providing a machine learning model that has previously been produced, e.g., by training a machine learning algorithm to produce the machine learning model. In some embodiments, the machine learning model is an autoregressive language model, such as, e.g., a machine learning model having a generative pretrained transformer (GPT) architecture (a “GPT model”) as described in, e.g., Brown (2020) Advances in Neural Information Processing Systems, Curran Associates, Inc. 33: 1877-1901; and Vaswani (2017) “Attention Is All You Need” arXiv: 1706.03762 [cs.CL], each of which is incorporated herein by reference.

The GPT model is a neural network comprising a self-attention mechanism, as discussed below (see also Vaswani, supra). The GPT model processes input sequences, such as an input sequence of integers produced by segmenting and tokenizing a textual representation of user interaction with the graphical user interface as described herein. The GPT model comprises a transformer, and the transformer comprises a decoder and an encoder. Each of the decoder and the encoder separately comprises a plurality of layers of multi-head self-attention and feedforward neural networks. The encoder receives an input sequence and transforms the input sequence to produce a set of hidden representations, and the set of hidden representations is input into the decoder. The decoder receives the set of hidden representations and generates an output sequence one member at a time.

The GPT model uses the self-attention mechanism to focus on specific parts of the input sequence to generate the output sequence. Each member in the input sequence is associated with a set of key, value, and query vectors, which are used to calculate attention scores between each member and every other member of the sequence. The attention scores are used to weight the importance of each member in the sequence when generating the output.

Further, the self-attention mechanism is a multi-head self-attention mechanism, thus allowing the GPT model to focus on multiple parts of the input sequence simultaneously (i.e., in parallel). In particular, each head of the multi-head self-attention mechanism focuses on one key, value, and query vector of the set of key, value, and query vectors, and each head separately calculates attention scores between sequence members. The outputs of the different heads are then concatenated and linearly transformed to produce the output.

In addition to the self-attention mechanism, the transformer also comprises a number of feedforward neural networks to process the hidden representations between each layer of the encoder and decoder. The feedforward networks comprise two linear transformations separated by a non-linear activation function (e.g., a rectified linear unit).

### Data Processing

As described herein, embodiments of the technology comprise providing data describing user interaction with a graphical user interface of an application and processing the data describing user interaction with a graphical user interface of an application to provide a textual representation of the user interaction with the graphical user interface. Accordingly, in some embodiments, the technology described herein comprises methods and systems for data preparation and preprocessing of data describing user interaction with a graphical user interface of an application. The data describing user interaction with a graphical user interface of an application may be in the form of a test case, test script, list, recorded user interactions, etc. describing a sequence of user actions performed on elements of a graphical user interface of an application. The technology comprises converting a sequence of user actions performed on elements of a graphical user interface of an application into a textual representation of user interaction with the graphical user interface.

The technology is not limited in the type of textual representation of user interaction with the graphical user interface. Accordingly, the type of textual representation of user interaction with the graphical user interface may be chosen from a range of types and formats used for data serialization and/or for electronic data exchange. In some embodiments, the textual representation of user interaction with the graphical user interface is formatted in a data structure comprising key-value pairs (also known as name-value pairs, attribute value pairs, or field-value pairs), wherein a key is a unique identifier that points to its associated value, and a value is either the data being identified or a pointer to that data. Exemplary formats for textual representation of user interaction with the graphical user interface include, e.g., ANSI ASC X12, Apache Avro, Apache Parquet, Apache Thrift, ASN.1 (e.g., ISO/IEC 8824/ITU-T X.680; and ISO/IEC 8825/ITU-T X.690 series. X.680, X.681, and X.683), Bencode, Binn, BSON, Cap'n_Proto, CBOR (e.g., RFC 8949), comma separated values (e.g., RFC 4180), common data representation (e.g., General Inter-ORB Protocol), D-Bus, Efficient XML Interchange (e.g., Efficient XML Interchange (e.g., EXI Format 1.0), FlatBuffers, Fast Infoset (e.g., ITU-T X.891; ISO/IEC 24824-1:2007), HTML (e.g., HTML element attributes), Ion, Java Object Serialization, JSON (e.g., ISO/IEC 21778:2017 and/or as described in Internet Engineering Task Force (IETF) Request for Comments 8259 (T. Bray, Ed., December 2017), ISSN: 2070-1721, incorporated herein by reference), MessagePack, Netstrings, OGDL, OPC-UA Binary, OpenDDL, PHP Serialization Format, Pickle (e.g., PEP 3154), Property List (e.g., Apple and NeXT Public XML DTD format), Protocol Buffers, SGML (e.g., SGML element attributes), S-expressions, Smile, SOAP (e.g., SOAP/1.1; SOAP/1.2), Structured Data eXchange Format (e.g., RFC 3072), UBJSON, UN/EDIFACT (e.g., ISO 9735), external Data Representation, (e.g., Standard 67; RFC 4506), XML (e.g., XML 1.0; XML 1.1), XML-RPC, and YAML (e.g., YAML version 1.2).

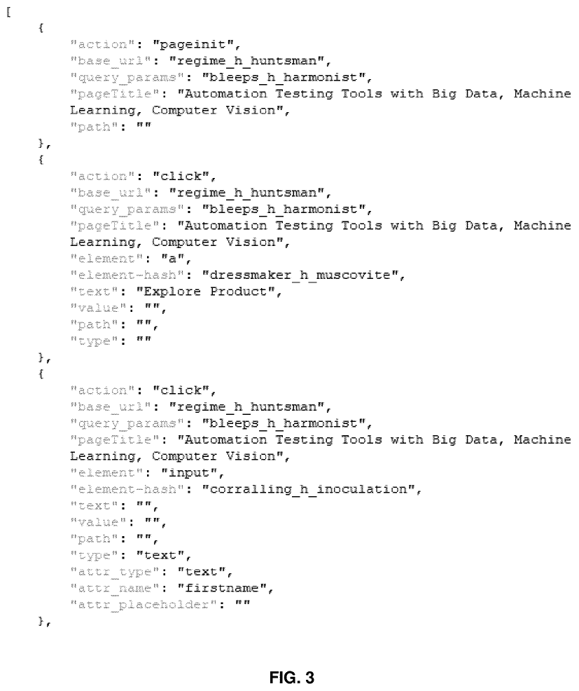

In some embodiments, methods comprise providing test case data in a textual representation of user interaction with the graphical user interface, segmenting the test case data in a textual representation into sentences, and tokenizing the sentences into words or subwords. In some embodiments, tokenizing further comprises converting the words or subwords into a sequence of integers using a dictionary that describes a one-to-one correspondence between an integer and each word or subword of a defined list of words and subwords in the dictionary vocabulary. In some embodiments, data processing comprises receiving test case data in a textual representation of user interaction with the graphical user interface; and then condensing the textual representation of user interaction with the graphical user interface, compressing the textual representation of user interaction with the graphical user interface (e.g., using use word pairs mapping), and/or removing data from the textual representation of user interaction with the graphical user interface that is not useful for model training (e.g., web page encoding). FIG. 3 shows a portion of an exemplary training dataset in a JSON-formatted textual representation of user interaction with the graphical user interface after condensing, compressing, and removing data that is not useful for model training.

Then, in some embodiments, data processing comprises tokenization as described herein to produce a sequence of integers (e.g., having values between 0-50000) using the dictionary to convert a word or subword of the dictionary vocabulary to a corresponding integer.

Accordingly, a sequence of user actions on a graphical user interface of an application may be encoded as a sequence of integers. In some embodiments, the sequence of integers finds use in training a machine learning model (e.g., a GPT model, a base model, a fine-tuned model). Furthermore, the output of a model as described herein may be in the form of a sequence of integers representing a sequence of user actions on a graphical user interface of an application; and the dictionary may be used to convert the sequence of integers to a sequence of actions on a graphical user interface described in a textual representation. In some embodiments, the output of a model as described herein may be in the form of a sequence of integers representing a sequence of user actions on a graphical user interface of an application and the dictionary may be used to convert the sequence of integers to a sequence of actions on a graphical user interface encoded in a programming language (e.g., a test script).

### Producing a Base Model

As described herein, embodiments of the technology comprise training a machine learning model with base user interaction training data to provide a base model. In some embodiments, the machine learning model is a deep learning model. In some embodiments, the machine learning model is an autoregressive language model, such as, e.g., a generative pretrained transformer (GPT) model. Brown (2020) Advances in Neural Information Processing Systems, Curran Associates, Inc. 33: 1877-1901; Vaswani (2017) “Attention Is All You Need” arXiv: 1706.03762 [cs.CL], each of which is incorporated herein by reference.

In some embodiments, a base model is produced by training the machine learning model (e.g., a GPT model) using a large body of manually scripted test cases and their associated textual representation. In some embodiments, manually scripted test cases describe sequential user actions performed on elements of a graphical user interface of an application. In some embodiments, each manually scripted test case of the number of manually scripted test cases is converted into a textual representation of the user action sequence. In some embodiments, the textual representation of the user action sequence is formatted using a standard format for data serialization and/or for electronic data exchange as described above in the section entitled Data processing. The base model is produced using scripted test cases that are broadly applicable to a wide range of applications and to a broad range of user use cases, and that have a reasonable distribution of test case lengths.

In particular, embodiments comprise training a GPT model with training data. Accordingly, embodiments provide that the base model is trained GPT model. After training, the trained base model (e.g., the trained GPT model) is trained to predict sequences of tokens representing user interactions with a graphical user interface (e.g., a series of user actions on elements of the graphical user interface). In some embodiments, the performance of the trained base model (e.g., the trained GPT model) is evaluated after training the base model. For example, in some embodiments, the base model is tested on a separate set of data that was not used for training, and the performance of the base model is measured using metrics such as accuracy, precision, recall, and F1 score.

In some embodiments, training the machine learning model (e.g., the GPT model) with base user interaction training data to provide a base model comprises providing human-scripted test cases to the machine learning model (e.g., a GPT model) and training the machine learning model using the human scripted test cases. After training the machine learning model with base user interaction training data, the base model recognizes the test case format and the contents of a test case unit. Furthermore, in some embodiments, the base model predicts sequences of user actions by performing a statistical analysis of the base user interaction training data, producing probabilities of user interaction sequences, and ranking probabilities of user interaction sequences to identify the relative likelihood of a particular user interaction sequence occurring during a user interaction with an application.

### Producing a Fine-Tuned Model

In some embodiments, the trained base model (e.g., the trained GPT model) is further trained to provide a fine-tuned model to predict user action sequences for a specific application. The process of fine-tuning comprises providing the base model (e.g., the GPT model trained with base user interaction training data) and further training the base model with an application-specific training dataset to provide a fine-tuned model adapted to perform test case generation (e.g., comprising a predicted sequence of user actions and probabilities associated with each user action) for a specific application and to predict the probabilities of data types and values entered into the application. In some embodiments, the method of fine-tuning comprises initializing the base model with pre-trained weights, and then training the base model using an application-specific training dataset describing user actions that are specific to the specified application. In some embodiments, the application-specific training dataset is a sequence of integers corresponding to a sequence of user actions on a graphical user interface, e.g., as described herein in the section entitled Data processing.

In some embodiments, the application-specific training dataset is collected from the actions of a number of users interacting with the application (e.g., a number of users each interacting with a graphical user interface of the application on a number of devices). Accordingly, in some embodiments, the application-specific training dataset is not necessarily limited to describing a sequence of user actions of a single user interacting with the graphical user interface of the application during a single session. Rather, in some embodiments, the application-specific training dataset provides data describing the collective actions of a plurality of users interacting with the application. Thus, in some embodiments, the application-specific training dataset provides data describing sequences of user actions performed by a number of users interacting with the application. In some embodiments, the application-specific training dataset provides data describing sequences of user actions performed by a number of users interacting with the application on a number of devices and/or the application-specific training dataset provides data describing sequences of user actions performed by a number of users interacting with the application at a number of different times.

Accordingly, the fine-tuned model is trained to recognize patterns (e.g., typical and/or predominant patterns) of user interaction with the application. In particular, the fine-tuned model is trained to recognize sequences of user actions to predict sequences of user actions that find use in producing test cases. Further, the fine-tuned model is trained to recognize acceptable user inputs produced by user actions.

In some embodiments, the application-specific training dataset comprises data from recording user actions while a user interacts with the graphical user interface of the application. In some embodiments, a recorder (e.g., a software snippet) is added to the application and the recorder records user actions on the application graphical user interface, e.g., as described below. In some embodiments, the application-specific training dataset comprises data from recording user actions performed by a number of users on a number of devices. In some embodiments, the application-specific training dataset comprises data from recording user actions performed by a number of users at a number of different times. In some embodiments, the application-specific training dataset is used to produce a probabilistic model describing user action sequences, types of data input by a user, and/or values of data input by a user. Accordingly, the application-specific training dataset finds use in predicting user action sequences, patterns of user actions, types of data input by a user, and/or values of data input by a user.

Fine-tuning (e.g., training the base model (e.g., the trained GPT model) with an application-specific training dataset to provide a fine-tuned model) significantly improves the performance of the model for a given application. Then, in some embodiments, sequences of user actions are input to the fine-tuned model to generate a large number of outputs describing user test cases for the application. The generated sequences of user actions are scored by providing a reward function or by training a reward model using a scoring system. The generated sequences of user actions output by the fine-tuned model are scored and then the reward model is trained to score the value of a given generated sequence. The reward model is then used to train a reinforcement learning model (e.g., a Proximal Policy Optimization (PPO) model) to learn to maximize the value leveraging the reward model of a generated sequence and thereby further adjusting the weights of the fine-tuned model.

### Live User Tracking

In some embodiments, a fine-tuned (application specific) model is produced for a single, specific application using data collected from live user tracking by monitoring user interactions with the graphical user interface of the specified application and using the data collected from live user tracking to train the base model and produce a fine-tuned (application-specific) model. In some embodiments, live user tracking monitors and records user interactions with the application graphical user interface. In some embodiments, live user tracking is performed by recording user interactions with an application as described in U.S. Pat. App. Pub. No. 20210397542, which is incorporated herein by reference. In some embodiments, live user tracking is performed for a number of users interacting with the application on a number of devices.

In some embodiments, the technology provides a recorder. In some embodiments, a recorder is a program (e.g., a background process, a desktop and/or screen sharing application, a virtual network computing (VNC) viewer, etc.) that monitors and observes user interactions with the application and records the user interactions. In some embodiments, a recorder is a small piece of code (e.g., an applet, a javascript snippet, a macro) added to an application (e.g., in a tag of the application) that monitors and observes user interactions with the application and records the user interactions. In some embodiments, the recorder records a user interaction with the application, the recorder sends the recorded action to a server, and the server produces a dataset of sequential user interactions. In some embodiments, the recorder records user interactions with the application, the recorder produces a dataset of sequential user interactions, and the recorder sends the dataset of sequential user interactions to the server. In some embodiments, a number of recorders records user interactions with the application for a number of users on a number of devices. In some embodiments, a number of recorders records user interactions with the application for a number of users at a number of times.

The dataset of sequential user actions is converted into a textual representation of the user action sequence. In some embodiments, the textual representation of the user action sequence is formatted using a standard format for data serialization and/or for electronic data exchange as described above in the section entitled Data processing. Then, the textual representation of the user action sequence is normalized and compressed to represent each user session of interacting with the application as a test case unit comprising a series of actions performed on elements of the application graphical user interface. In some embodiments, the dataset of sequential user actions is sent to a backend system and the backend system converts the dataset of sequential user actions into a textual representation of the user action sequence.

### Producing and Using Element Definitions

In some embodiments, the technology relates to element definitions, producing an element definition for an element of a graphical user interface of an application, and using an element definition to identify an element and/or a class of elements of a graphical user interface of an application.

In particular, an element definition comprises a description of an element or a class of elements using element attributes and/or element attribute values. For example, in some embodiments, an element definition comprises one or more of data describing the visual render of the element (element render data), data describing the text (e.g., a text string) of the element (element text data), data describing the code that generates the element (element code data), and/or data characterizing the elements surrounding an element and the relationships between an element and other elements on the page, including, in some embodiments, using distributions of element attribute values (element context data).

In some embodiments, the technology relates to producing an element definition for an element. In some embodiments, an element definition is produced using element attributes and/or attribute values. In some embodiments, producing an element definition comprises using an element definition model that produces the element definition using one or more of the element visual render, a text string of the element, the code that generates the element, and/or element context (e.g., the surroundings and relation of each element to other elements and distributions of element attribute values). In some embodiments, an element definition is produced for an element by weighting the contributions of one or more attributes, e.g., one or more of the element render data, the element text data, the element code data, and/or the element context data and calculating the element definition from the weighted attributes, e.g., the weighted element render data, the weighted element text data, the weighted element code data, and/or the weighted element context data. In some embodiments, weighting an attribute comprises multiplying a value describing the attribute (e.g., element render data, the element text data, the element code data, and/or the element context data by a coefficient and/or adding a value to the value describing the attribute (e.g., element render data, the element text data, the element code data, and/or the element context data). In some embodiments, the technology described herein provides scoring models for evaluating and/or quantifying each of element render data, element text data, element code data, and/or element context data, e.g., for producing an element definition. In some embodiments, methods and systems for defining an element e.g., methods comprising producing an element definition and systems configured to produce an element definition, are described in U.S. Pat. App. Pub. No. 2021/0397546, which is incorporated herein by reference.

In some embodiments, an element definition is produced for an element acted upon by a user during live user tracking. That is, in some embodiments, the technology comprises monitoring user interactions with the graphical user interface of the specified application and producing element definitions for a number of elements that are the targets of the monitored user actions. In some embodiments, the technology comprises monitoring user interactions with the graphical user interface of the specified application, recording user interactions, and producing element definitions for a number of elements that are the targets of the recorded user actions.

In some embodiments, the application-specific training dataset provides data describing sequences of user actions performed by a number of users interacting with the application and in which the target elements of user actions are described using element definitions. Accordingly, in some embodiments, the technology provides a method comprising training the base model with an application-specific training dataset to provide a fine-tuned model and in which the target elements of user actions are described using element definitions.

In some embodiments, the technology produces a unique element reference associated with the element definition and stores the element definition and the element reference in a data structure that associates the element definition with the element reference. In some embodiments, element references are used in a training dataset (e.g., a base user interaction training dataset and/or an application-specific training dataset) comprising sequences of user actions. In some embodiments, element references are used in a test script comprising a sequence of user actions. In particular, in some embodiments, user actions provided in a test script are described using an element reference and an action to be performed on an element. When the test script is executed, the element reference is used to identify an element using the stored element definition associated with the element reference indicated in the test script. In some embodiments, a textual representation of a user interaction with a graphical user interface describes a test step comprising a reference to an element definition (e.g., instead of comprising an identifier that directly identifies an element). Accordingly, embodiments provide test cases, test scripts, and training datasets comprising a textual representation of a user interaction with a graphical user interface in which a test step comprises a reference to an element definition and an action.

In some embodiments, the application-specific training dataset provides data describing sequences of user actions performed by a number of users interacting with the application and in which the target elements of user actions are described using references to element definitions. Accordingly, in some embodiments, the technology provides a method comprising training the base model with an application-specific training dataset to provide a fine-tuned model and in which the target elements of user actions are described using references to element definitions.

Further, in some embodiments, the technology relates to using an element definition to identify an element and/or a class of elements on a graphical user interface of an application. In particular, embodiments of the technology provide methods for identifying an element on a graphical user interface using an element definition of a target element (e.g., as provided in a test script or as associated with an element reference provided in a test script). In some embodiments, methods for identifying elements on a graphical user interface using an element definition of a target element comprise identifying a number of elements on a graphical user interface of an application (e.g., a plurality of elements and/or all or substantially all elements of a graphical user interface of an application) to provide a set of elements and producing an element definition for each element of the set of elements to provide a set of element definitions for the graphical user interface. Then, a probabilistic matching model is used to determine a probability that each element definition of the set of element definitions for the graphical user interface is a match with the element definition of the target element (e.g., as provided in a test script or as associated with an element reference provided in a test script). In some embodiments, the probabilistic matching model ranks the elements in the set of elements according to the probability that each element in the set of elements is the target element to provide a ranked list of elements. In some embodiments, the action of a test script step is performed on a plurality of the ranked list of elements and the outcome of the test step is evaluated.

### Uses, Model Inference, and Test Case Generation

Thus, according to embodiments of the technology described herein, the base model and the fine-tuned model generate a sequence of user actions to provide a test case. In some embodiments, the sequence of user actions is provided as a sequence of integers. In some embodiments, a dictionary may be used to convert the sequence of integers to a sequence of actions on a graphical user interface described in a textual representation. Thus, in some embodiments, the sequence of user actions is provided as a textual representation of the user action sequence. In some embodiments, the textual representation of the user action sequence is formatted using a standard format for data serialization and/or for electronic data exchange as described above in the section entitled Data processing. In some embodiments, the output of a model as described herein may be in the form of a sequence of integers representing a sequence of user actions on a graphical user interface of an application and the dictionary may be used to convert the sequence of integers to a sequence of actions on a graphical user interface encoded in a programming language (e.g., a test script).

Further, the technology comprises a runtime agent that simulates user actions on an application. The runtime agent is configured to request a predicted next step from the fine-tuned model at runtime and receives the predicted next step from the fine-tuned model. The runtime agent then evaluates the prediction by attempting to execute the predicted next test step and then request another next step or request an alternative step from the fine-tuned model. In some embodiments, the agent may be configured for various modes of test case generation and levels of randomness. In some embodiments, the agent may be configured to receive specified inputs or to perform certain end goals.

Further, the technology further comprises methods for generating program code (e.g., a test script) from the token sequence produced by the fine-tuned model. In particular, the token sequence may be converted to a particular simulated user interaction (e.g., comprising a sequence of user actions on application graphical user interface elements) on an application for use in generating executable code in one or more languages that can perform the simulated user interaction on the application graphical user interface.

In addition to outputting a test script describing a sequence of user actions performed on element of a graphical user interface of an application (e.g., a test case), the technology provides embodiments of using the GPT model to generate test data. For example, in some embodiments, a GPT model may be trained solely using user inputs on the graphical user interface of an application. User inputs (e.g., pairs of inputs (element identifier and input value)) are provided to the GPT model and the GPT model is trained to classify and learn the types of inputs provided by users and to learn the bounds and ranges of expected values. Accordingly, the trained GPT model may generate any data type matching the learned inputs and may generate in or out of bound values as part of the test case generation.

Although the disclosure herein refers to certain illustrated embodiments, it is to be understood that these embodiments are presented by way of example and not by way of limitation.

All publications and patents mentioned in the above specification are herein incorporated by reference in their entirety for all purposes. Various modifications and variations of the described compositions, methods, and uses of the technology will be apparent to those skilled in the art without departing from the scope and spirit of the technology as described. Although the technology has been described in connection with specific exemplary embodiments, it should be understood that the invention as claimed should not be unduly limited to such specific embodiments. Indeed, various modifications of the described modes for carrying out the invention that are obvious to those skilled in the art are intended to be within the scope of the following claims.

We claim:

1. A method for generating a software application test case for an application, the method comprising:
providing a machine learning model;
training the machine learning model with a base user interaction training dataset to produce a base model; and
training the base model with an application specific training dataset to provide a fine-tuned model for an application.

2. The method of claim 1, further comprising generating by the fine tuned model a software application test case comprising a sequence of user actions on a graphical user interface of the application.

3. The method of claim 1, wherein the machine learning model is a generative pretrained transformer.

4. The method of claim 1, wherein the base user interaction training dataset comprises a large corpus of manually scripted software test cases.

5. The method of claim 4, wherein each manually scripted software test case of the large corpus of manually scripted software test cases is provided in a standard format for data serialization and/or data interchange.

6. The method of claim 1, wherein the base user interaction training dataset comprises a plurality of software test cases for a wide range of applications, a wide range of use cases, and/or has a reasonable distribution of test case lengths.

7. The method of claim 1, wherein the application specific training dataset is provided by recording user actions on a graphical user interface of the application.

8. The method of claim 7, wherein the dataset of sequential user actions is provided in a standard format for data interchange.

9. The method of claim 1, wherein the application-specific training dataset comprises data:
1) describing sequences of user actions performed by a number of users interacting with the application;
2) data describing sequences of user actions performed by a number of users interacting with the application on a number of devices; and/or
3) data describing sequences of user actions performed by a number of users interacting with the application at a number of different times

10. The method of claim 1, further comprising inputting to the fine-tuned model a sequence of user actions on a graphical user interface of an application to generate a software application test case comprising a sequence of user actions on a graphical user interface of the application; scoring the software application test case using a reward model; training a reinforcement learning model; and adjusting weights of the fine-tuned model.

11. The method of claim 10, wherein the reinforcement learning model is a Proximal Policy Optimization (PPO) model.

12. The method of claim 1, further comprising:
providing a runtime agent;
requesting by the runtime agent a predicted next step from the fine-tuned model for an application at runtime of the application; and
executing the predicted next step on the application.

13. The method of claim 2, further comprising generating executable code in a programming language to perform the software application test case.

14. A system for generating a software application test case for an application, the system comprising:
a machine learning model;
a base user interaction training dataset; and
an application specific training dataset.

15. The system of claim 14, wherein the machine learning model is a generative pretrained transformer.

16. The system of claim 14, wherein the base user interaction training dataset comprises a large corpus of manually scripted software test cases.

17. The system of claim 16, wherein each manually scripted software test case of the large corpus of manually scripted software test cases is provided in a standard format for data serialization and/or data interchange.

18. The system of claim 16, wherein the base user interaction training dataset comprises a plurality of software test cases for a wide range of applications, a wide range of use cases, and/or has a reasonable distribution of test case lengths.

19. The system of claim 14, further comprising a code snippet comprising instructions for recording user actions on a graphical user interface of the application to provide a dataset of sequential user actions.

20. The system of claim 18, wherein the dataset of sequential user actions is provided in a standard format for data interchange.

21. The system of claim 14, further comprising a dictionary that:
comprises a list of integers and a vocabulary of words or subwords; and
defines a one to one correspondence between each integer of the list of integers and each word or subword of the vocabulary.

22. The system of claim 14, further a reward model and a reinforcement learning model.

23. The system of claim 22, wherein the reinforcement learning model is a Proximal Policy Optimization (PPO) model.

24. The system of claim 14, further comprising a runtime agent.
